(19) United States
(12) Patent Application Publication
(10) Pub. No.: US 2012/0210254 A1
(43) Pub. Date: Aug. 16, 2012

(54) INFORMATION PROCESSING APPARATUS, INFORMATION SHARING METHOD, PROGRAM, AND TERMINAL DEVICE

(76) Inventors: Masaki FUKUCHI, Tokyo (JP); Tatsuki Kashitani, Tokyo (JP); Shunichi Homma, Tokyo (JP); Takayuki Yoshigahara, Tokyo (JP)

(21) Appl. No.: 13/364,029

(22) Filed: Feb. 1, 2012

(30) Foreign Application Priority Data
Feb. 10, 2011 (JP) 2011-027654

(51) Int. Cl. G06F 3/048

(52) U.S. Cl. 715/757

(57) ABSTRACT

An apparatus for sharing virtual objects may include a communication unit and a sharing control unit. The communication unit may be configured to receive position data indicating a position of a virtual object relative to a real space. The sharing control unit may be configured to compare the position of the virtual object to a sharing area that is defined relative to the real space. The sharing control unit may also be configured to selectively permit display of the virtual object by a display device, based on a result of the comparison.

### CROSS-REFERENCE TO RELATED APPLICATION

This application claims priority of Japanese Patent Application No. 2011-027654, filed on Feb. 10, 2011, the entire content of which is hereby incorporated by reference.

### BACKGROUND

The present disclosure relates to an information processing apparatus, an information sharing method, a program, and a terminal device.

In recent years, a technology called Augmented Reality (AR) for superimposing additional information onto the real world and presenting it to users is gaining attention. Information to be presented to users in the AR technology is also called annotation, and may be visualized by using various types of virtual objects such as texts, icons, animations, and the like. One of the main application fields of the AR technology is the supporting of user activities in the real world. The AR technology is used for supporting not only the activities of a single user, but also the activities of multiple users (for example, see JP 2004-62756A and JP 2005-49996A).

### SUMMARY

However, when multiple users share an AR space, an issue arises as to which information is to be presented to which user. For example, at a meeting in the real world, many of the participants of the meeting take notes on their own ideas or the contents of the meeting, but they do not wish other participants to freely view the notes. However, the methods described in JP 2004-62756A and JP 2005-49996A do not distinguish between information to be shared between users and information that an individual user does not wish to share, and there is a concern that multiple users will be able to view any information regardless of the intention of a user.

In the existing AR technology, it was possible to prepare two types of AR spaces, a private layer (hierarchical level) and a shared layer, and by using these layers while switching between them, users were allowed to separately hold information to be shared and information not desired to be shared. However, handling of such multiple layers was burdensome to the users, and also the operation of changing the setting of the layer was non-intuitive and complicated.

In light of the foregoing, it is desirable to provide an information processing apparatus, an information sharing method, a program, and a terminal device, which allow a user to easily handle information desired to be shared with other users in an AR space and information not desired to be shared.

Accordingly, there is disclosed an apparatus for sharing virtual objects. The apparatus may include a communication unit and a sharing control unit. The communication unit may be configured to receive position data indicating a position of a virtual object relative to a real space. The sharing control unit may be configured to compare the position of the virtual object to a sharing area that is defined relative to the real space. The sharing control unit may also be configured to selectively permit display of the virtual object by a display device, based on a result of the comparison.

There is also disclosed a method of sharing virtual objects. A processor may execute a program to cause an apparatus to perform the method. The program may be stored on a storage medium of the apparatus and/or a non-transitory, computer-readable storage medium. The method may include receiving position data indicating a position of a virtual object relative to a real space. The method may also include comparing the position of the virtual object to a sharing area that is defined relative to the real space. Additionally, the method may include selectively permitting display of the virtual object by a display device, based on a result of the comparison.

According to the information processing apparatus, the information sharing method, the program, and the terminal device of the present disclosure, a user is allowed to easily handle information desired to be shared with other users in the AR space and information not desired to be shared.

### BRIEF DESCRIPTION OF THE DRAWINGS

FIG. 1A is an explanatory diagram showing an overview of an information sharing system according to an embodiment;

FIG. 1B is an explanatory diagram showing another example of the information sharing system;

FIG. 2 is a block diagram showing an example of the configuration of a terminal device (i.e., a remote device) according to an embodiment;

FIG. 3 is an explanatory diagram showing an example of an image captured by a terminal device according to an embodiment;

FIG. 4 is an explanatory diagram showing an example of an image displayed by a terminal device according to an embodiment;

FIG. 5 is a block diagram showing an example of the configuration of an information processing apparatus according to an embodiment;

FIG. 6 is an explanatory diagram for describing object data according to an embodiment;

FIG. 7 is an explanatory diagram for describing sharing area data according to an embodiment;

FIG. 8 is an explanatory diagram showing a first example of a sharing area;

FIG. 9 is an explanatory diagram showing a second example of the sharing area;

FIG. 10 is an explanatory diagram showing a third example of the sharing area;

FIG. 11 is an explanatory diagram for describing an example of a method of supporting recognition of a sharing area;

FIG. 12 is a sequence chart showing an example of the flow of a process up to the start of information sharing in an embodiment;

FIG. 13 is a flow chart showing an example of the flow of a sharing determination process according to an embodiment;

FIG. 14 is an explanatory diagram for describing calculation of a display position of a virtual object;

FIG. 15 is an explanatory diagram showing examples of shared information and non-shared information in an embodiment;

FIG. 16 is an explanatory diagram for describing a first scenario for sharing information that was non-shared in FIG. 15;

FIG. 17 is an explanatory diagram for describing a second scenario for sharing information that was non-shared in FIG. 15; and

FIG. 18 is an explanatory diagram showing an overview of an information sharing system according to a modified example.

### DETAILED DESCRIPTION OF THE EMBODIMENT(S)

Hereinafter, embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted. Note also that, as used herein, the indefinite articles “a” and “an” mean “one or more” in open-ended claims containing the transitional phrase “comprising,” “including,” and/or “having.”

Also, in the following, the “DETAILED DESCRIPTION OF THE EMBODIMENT(S)” will be described in the following order.
1. Overview of System
2. Example Configuration of Terminal Device
3. Example Configuration of Information Processing Apparatus
4. Example of Flow of Process
5. Examples of Shared Information and Non-Shared Information
6. Modified Example
7. Summary

### 1. Overview of System

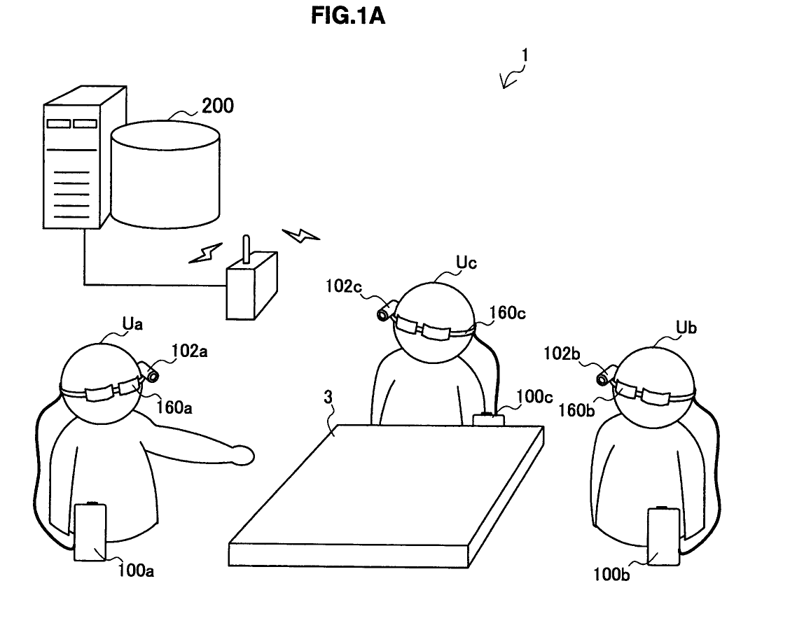

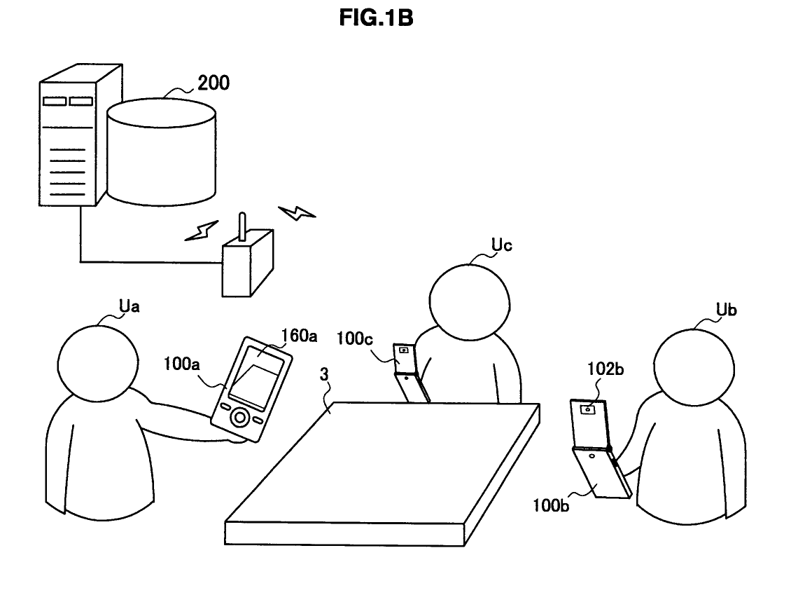

FIG. 1A is an explanatory diagram showing an overview of an information sharing system 1 according to an embodiment of the present disclosure. Referring to FIG. 1A, the information sharing system 1 includes terminal devices 100a, 100b, and 100c, and an information processing apparatus 200. In the example of FIG. 1A, users Ua, Ub, and Uc surround a table 3 which is a real object in the real space. The user Ua uses the terminal device 100a, the user Ub uses the terminal device 100b, and the user Uc uses the terminal device 100c, respectively. Additionally, an example is shown in FIG. 1A where three users participate in the information sharing system 1, but it is not limited to such an example, and two or four or more users may participate in the information sharing system 1.

The terminal device 100a is connected to an imaging device 102a and a display device 160a that are mounted on the head of the user Ua. The imaging device 102a turns toward the direction of the line of sight of the user Ua, captures the real space, and output a series of input images to the terminal device 100a. The display device 160a displays to the user Ua an image of a virtual object generated or acquired by the terminal device 100a. The screen of the display device 160a may be a see-through screen or a non-see-through screen. In the example of FIG. 1A, the display device 160a is a head-mounted display (HMD).

The terminal device 100b is connected to an imaging device 102b and a display device 160b that are mounted on the head of the user Ub. The imaging device 102b turns toward the direction of the line of sight of the user Ub, captures the real space, and outputs a series of input images to the terminal device 100b. The display device 160b displays to the user Ub an image of a virtual object generated or acquired by the terminal device 100b.

The terminal device 100c is connected to an imaging device 102c and a display device 160c that are mounted on the head of the user Uc. The imaging device 102c turns toward the direction of the line of sight of the user Uc, captures the real space, and outputs a series of input images to the terminal device 100c. The display device 160c displays to the user Uc an image of a virtual object generated or acquired by the terminal device 100c.

The terminal devices 100a, 100b, and 100c communicate with the information processing apparatus 200 via a wired or wireless communication connection. The terminal devices 100a, 100b, and 100c may also be able to communication with each other. The communication between the terminal devices 100a, 100b, and 100c, and the information processing apparatus 200 may be performed directly by a P2P (Peer to Peer) method, or may be performed indirectly via another device such as a router or a server (not shown), for example.

The terminal device 100a superimposes information owned by the user Ua and information shared among the users Ua, Ub, and Uc onto the real space and displays the same on the screen of the display device 160a. The terminal device 100b superimposes information owned by the user Ub and information shared among the users Ua, Ub, and Uc onto the real space and displays the same on the screen of the display device 160b. The terminal device 100c superimposes information owned by the user Uc and information shared among the users Ua, Ub, and Uc onto the real space and displays the same on the screen of the display device 160c.

Additionally, the terminal devices 100a, 100b, and 100c may be mobile terminals with cameras, such as smartphones, without being limited to the example of FIG. 1A (see FIG. 1B). In such a case, the camera of a mobile terminal with a camera captures the real space and image processing is performed by a control unit (i.e., a software module, a hardware module, or a combination of a software module and a hardware module) of the terminal, and then the image of a virtual image may be superimposed onto the image of the real space and be displayed on the screen of the terminal. Also, each terminal device may be a device of another type, such as a PC (Personal Computer), a game terminal, or the like.

In the following description of the present specification, in a case the terminal devices 100a, 100b, and 100c do not have to be distinguished from each other, the alphabets at the end of the reference numerals are omitted and they will be collectively referred to as the terminal device 100. The same also applies to the imaging devices 102a, 102b, and 102c (the imaging device 102), the display devices 160a, 160b, and 160c (the display device 160), and other elements.

The information processing apparatus 200 is an apparatus that operates as a server that supports sharing of information between a plurality of terminal devices 100. In the present embodiment, the information processing apparatus 200 holds object data that indicates the position and the attribute of a virtual object. The virtual object may be a text box in which some kind of text information, such as a label, a balloon or a message tag, for example, is written. Also, the virtual object may be a diagram or a symbol, such as an icon, for example, that symbolically expresses some kind of information. Furthermore, the information processing apparatus 200 holds sharing area data that defines a sharing area that is set in common within the information sharing system 1. The sharing area may be defined in association with a real object in the real space, such as the table 3, for example, or it may be defined as a specific area in a coordinate system of the real space without being associated with a real object. Also, the information processing apparatus 200 controls sharing of each virtual object according to the attribute of each virtual object and the positional relationship of each virtual object to the sharing area.

The concrete example of the configuration of each device of such an information sharing system 1 will be described in detail in the following section.

### 2. Example Configuration of Terminal Device

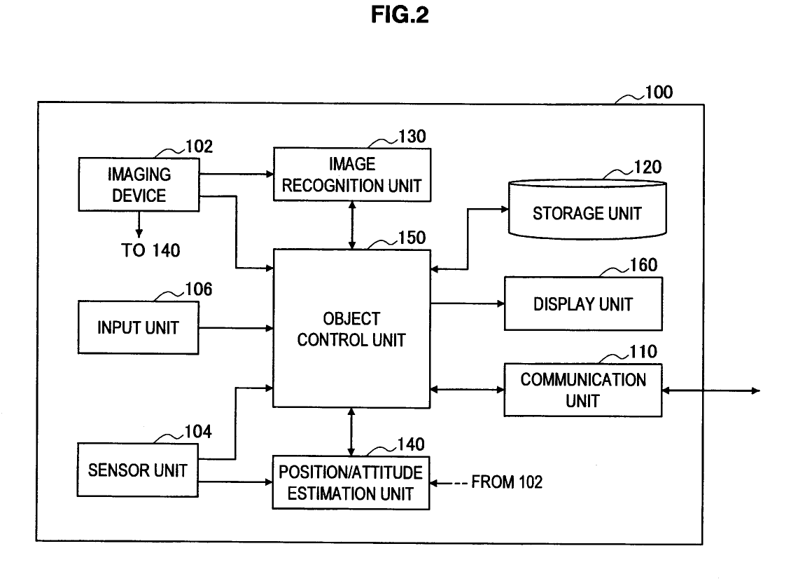

FIG. 2 is a block diagram showing an example of the configuration of the terminal device 100 according to the present embodiment. Referring to FIG. 2, the terminal device 100 includes an imaging unit 102, a sensor unit 104, an input unit 106, a communication unit 110, a storage unit 120, an image recognition unit 130, a position/attitude estimation unit 140, an object control unit 150, and a display unit 160.

The imaging unit 102 corresponds to the imaging device 102 of the terminal device 100 shown in FIG. 1A or 1B, and it acquires a series of input images by capturing the real space. Then, the imaging unit 102 outputs the acquired input image to the image recognition unit 130, the position/attitude estimation unit 140, and the object control unit 150.

The sensor unit 104 includes at least one of a gyro sensor, an acceleration sensor, a geomagnetic sensor, and a GPS (Global Positioning System) sensor. The tilt angle, the 3-axis acceleration, or the orientation of the terminal device 100 measured by the gyro sensor, the acceleration sensor, or the geomagnetic sensor may be used to estimate the attitude of the terminal device 100. Also, the GPS sensor may be used to measure the absolute position (latitude, longitude, and altitude) of the terminal device 100. The sensor unit 104 outputs the measurement value obtained by measurement by each sensor to the position/attitude estimation unit 140 and the object control unit 150.

The input unit 106 is used by the user of the terminal device 100 to operate the terminal device 100 or to input information to the terminal device 100. The input unit 106 may include a keypad, a button, a switch, or a touch panel, for example. Also, the input unit 106 may include a speech recognition module that recognizes, from voice uttered by a user, an operation command or an information input command, or a gesture recognition module that recognizes a gesture of a user reflected on an input image. A user moves a virtual object displayed on the screen of the display unit 160, for example, by an operation via the input unit 106 (for example, dragging of the virtual object, press-down of a direction key, or the like). Also, the user edits the attribute of the virtual object that he/she owns via the input unit 106.

The communication unit 110 is a communication interface that intermediates communication connection between the terminal device 100 and another device. When the terminal device 100 joins the information sharing system 1, the communication unit 110 establishes the communication connection between the terminal device 100 and the information processing apparatus 200. Also, the communication unit 110 may further establish a communication connection between a plurality of terminal devices 100. Communication for sharing information between users in the information sharing system 1 is thereby enabled.

The storage unit 120 stores a program and data used for processing by the terminal device 100 by using a storage medium (i.e., a non-transitory, computer-readable storage medium) such as a hard disk, a semiconductor memory or the like. For example, the storage unit 120 stores object data of a virtual object that is generated by the object control unit 150 or acquired from the information processing apparatus 200 via the communication unit 110. Furthermore, the storage unit 120 stores sharing area data regarding a sharing area with which the user of the terminal device 100 is registered.

The image recognition unit 130 performs image recognition processing for the input image input from the imaging unit 102. For example, the image recognition unit 130 may recognize, using a known image recognition method, such as pattern matching, a real object in the real space that is shown in the input image and that is associated with a sharing area (for example, the table 3 shown in FIG. 1A or 1B). Alternatively, the image recognition unit 130 may recognize, within the input image, a mark, a QR code, or the like, that is physically attached to a real object.

The position/attitude estimation unit 140 estimates the current position and attitude of the terminal device 100 by using the measurement value of each sensor input from the sensor unit 104. For example, the position/attitude estimation unit 140 is capable of estimating the absolute position of the terminal device 100 by using the measurement value of the GPS sensor. Also, the position/attitude estimation unit 140 is capable of estimating the attitude of the terminal device 100 by using the measurement value of the gyro sensor, the acceleration sensor, or the geomagnetic sensor. Alternatively, the position/attitude estimation unit 140 may estimate the relative position or attitude of the terminal device 100 to the real object in a real space based on the result of image recognition by the image recognition unit 130. Furthermore, the position/attitude estimation unit 140 may also dynamically detect the position and the attitude of the terminal device 100 by using an input image input from the imaging unit 102, according to the principle of SLAM technology described in “Real-Time Simultaneous Localization and Mapping with a Single Camera” (Proceedings of the 9th IEEE International Conference on Computer Vision Volume 2, 2003, pp. 1403-1410) by Andrew J. Davison, for example. Additionally, in the case of using SLAM technology, the sensor unit 104 may be omitted from the configuration of the terminal device 100. The position/attitude estimation unit 140 outputs the position and the attitude of the terminal device 100 estimated in the above manner to the object control unit 150.

The object control unit 150 controls operation and display of a virtual object on the terminal device 100.

More particularly, the object control unit 150 generates a virtual object that expresses information that is input or selected by a user. For example, one of three users surrounding the table 3 inputs, via the input unit 106 and in the form of text information, information regarding notes on ideas that he/she has come up with during a meeting or the minutes of the meeting. Then, the object control unit 150 generates a virtual object (for example, a text box) showing the input text information. The user of the terminal device 100 which has generated the virtual object becomes the owner of the virtual object. Furthermore, the object control unit 150 associates the generated virtual object with a position in the real space. The position with which the virtual object is to be associated may be a position specified by the user or a position set in advance. Then, the object control unit 150 transmits object data indicating the position and the attribute of the generated object to the information processing apparatus 200 via the communication unit 110.

Also, the object control unit 150 acquires from the information processing apparatus 200, via the communication unit 110, object data regarding a virtual object which has been allowed to be displayed according to the positional relationship between the sharing area and each virtual object. Then, the object control unit 150 calculates the display position of each virtual object on the screen based on the three-dimensional position of each virtual object indicated by the acquired object data and the position and the attitude of the terminal device 100 estimated by the position/attitude estimation unit 140. Then, the object control unit 150 causes each virtual object to be displayed, by the display unit 160, at a display position which has been calculated.

Furthermore, the object control unit 150 acquires from the information processing apparatus 200, via the communication unit 110, sharing area data defining a virtual sharing area set in the real space. Then, the object control unit 150 causes an auxiliary object (for example, a semitransparent area or a frame that surrounds the sharing area) for allowing the user to perceive the sharing area to be displayed by the display unit 160. The display position of the auxiliary object may be calculated based on the position of the sharing area indicated by the sharing area data and the position and the attitude of the terminal device 100.

Also, the object control unit 150 causes the virtual object displayed by the display unit 160 to be moved, according to a user input detected via the input unit 106. Then, the object control unit 150 transmits the new position of the virtual object after the movement to the information processing apparatus 200 via the communication unit 110.

The display unit 160 corresponds to the display device 160 of the terminal device 100 shown in FIG. 1A or 1B. The display unit 160 superimposes the virtual object acquired from the information processing apparatus 200 onto the real space at the display position calculated by the object control unit 150, and displays the same. Also, the display unit 160 superimposes onto the real space the auxiliary object for allowing the user to perceive the sharing area, according to the sharing area data acquired from the information processing apparatus 200, and displays the same.

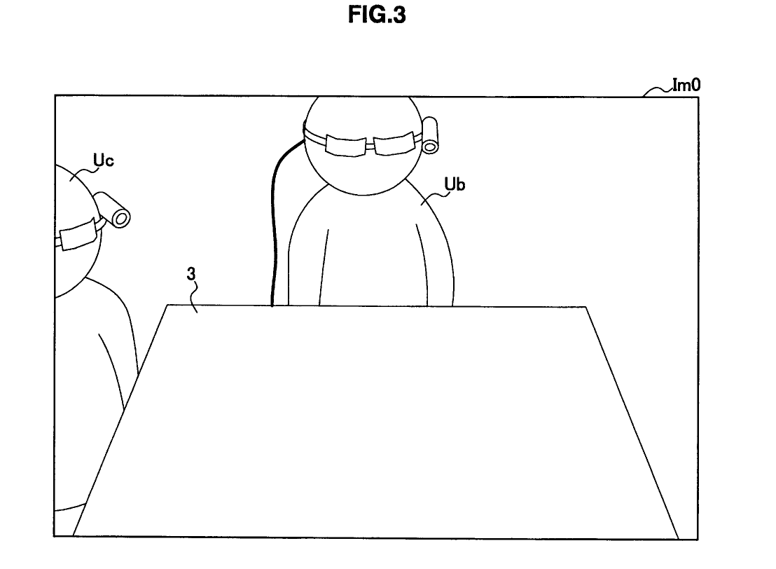

FIG. 3 is an explanatory diagram showing an example of an image captured by the imaging unit 102 of the terminal device 100. Referring to FIG. 3, an input image Im0 captured from the viewpoint of the user Ua is shown. The users Ub and Uc and the table 3 are shown in the input image Im0.

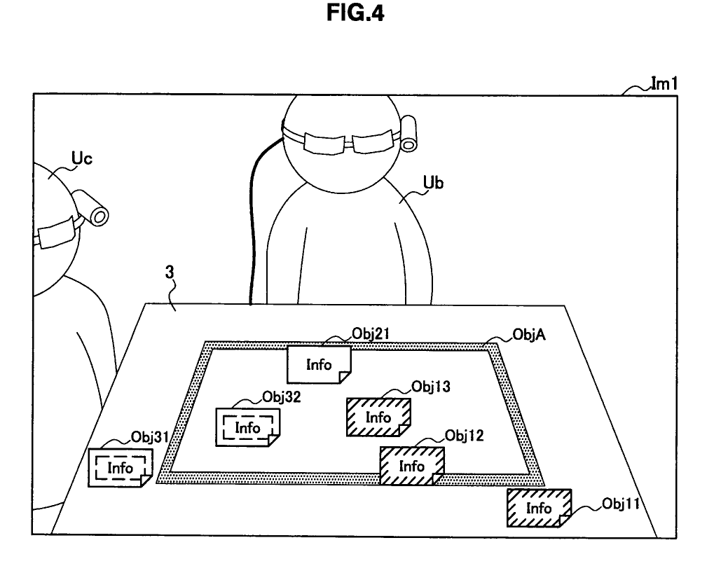

FIG. 4 is an explanatory diagram showing an example of an image displayed by the display unit 160 of the terminal device 100 (100a). Referring to FIG. 4, a plurality of objects Obj11, Obj12, Obj13, Obj21, Obj31, Obj32, and ObjA are displayed being superimposed onto the table 3, in the real space, that is shown in the input image Im0 of FIG. 3. For example, the objects Obj11, Obj12, and Obj13 are virtual objects expressing the information that the user Ua has input. The object Obj21 is a virtual object expressing the information that the user Ub has input. The objects Obj31, and Obj32 are virtual objects expressing the information that the user Uc has input. The object ObjA is an auxiliary object for allowing the user to perceive the sharing area. In the information sharing system 1, with the involvement of the information processing apparatus 200 which will be described next, an AR space that displays such objects is presented to users, and easy and flexible sharing of information among the users is enabled.

### 3. Example Configuration of Information Processing Apparatus

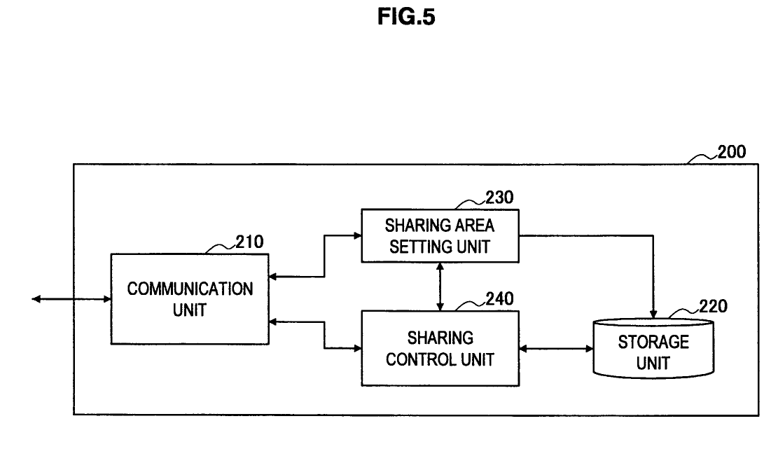

FIG. 5 is a block diagram showing an example of the configuration of the information processing apparatus 200 according to the present embodiment. Referring to FIG. 5, the information processing apparatus 200 includes a communication unit 210, a storage unit 220, a sharing area setting unit (i.e., a sharing area defining unit) 230, and a sharing control unit 240.

(3-1) Communication Unit

The communication unit 210 is a communication interface that intermediates communication connection between the information processing apparatus 200 and the terminal device 100. When a request for joining the information sharing system 1 is received from a terminal device 100, the communication unit 210 establishes a communication connection with the terminal device 100. Exchange of various data, such as the object data, the sharing area data, and the like, between the terminal device 100 and the information processing apparatus 200 is thereby enabled.

(3-2) Storage Unit

The storage unit 220 stores the object data regarding a virtual object superimposed onto the real space and displayed on the screen of each terminal device 100. Typically, the object data includes positional data indicating the position of each object in the real space and attribute data indicating the attribute of each object. The storage unit 220 also stores the sharing area data defining a sharing area that is virtually set in the real space. The sharing area data includes data regarding the range of each sharing area in the real space. Furthermore, the sharing area data may also include data regarding the user who uses each sharing area.

(Object Data)

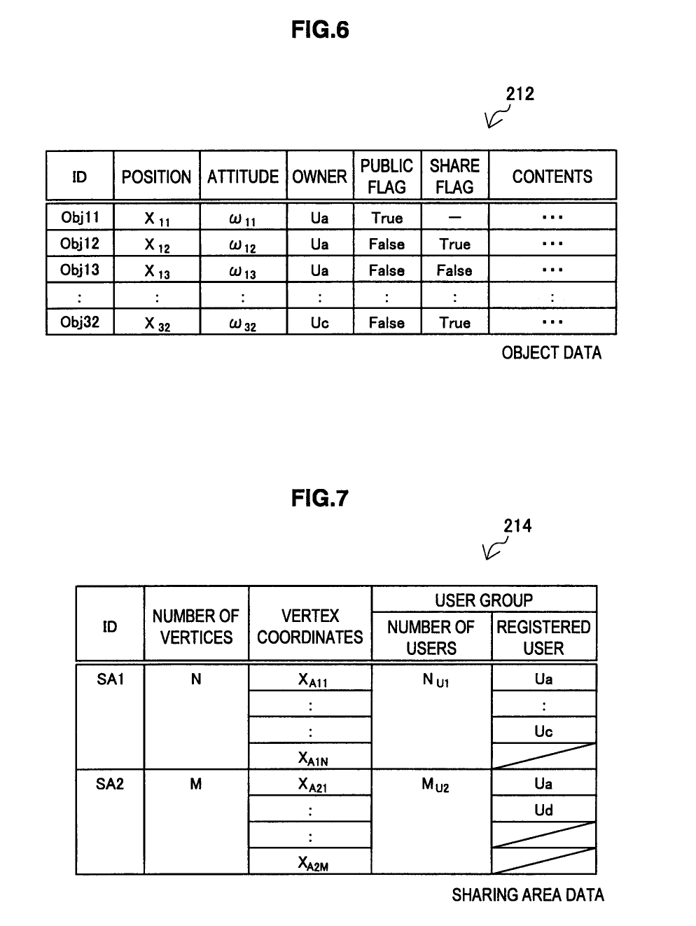

FIG. 6 is an explanatory diagram for describing the object data to be stored by the information processing apparatus 200 in the present embodiment. Referring to FIG. 6, object data 212, which is an example, is shown. The object data 212 includes seven data items: an object ID, a position, an attitude, an owner, a public flag, a share flag, and contents.

The “object ID” is an identifier used for unique identification of each virtual object. The “position” indicates the position of each virtual object in the real space. The position of each virtual object in the real space may be expressed by global coordinates indicating an absolute position such as latitude, longitude, and altitude, or may be expressed by local coordinates that is set in association with a specific space (for example, a building, a meeting room, or the like), for example. The “attitude” indicates the attitude of each virtual object using a quaternion or Euler angles. The “owner” is a user ID used for identifying the owner user of each object. In the example of FIG. 6, the owner of the objects Obj11, Obj12, and Obj13 is the user Ua. On the other hand, the owner of the object Obj32 is the user Uc.

The “public flag” is a flag defining the attribute, public or private, of each virtual object. A virtual object whose “public flag” is “True” (that is, a virtual object having a public attribute) is basically made public to all the users regardless of the position of the virtual object. On the other hand, with regard to a virtual object whose “public flag” is “False” (that is, a virtual object having a private attribute), whether or not it is to be made public is determined according to the value of the share flag and the position of the virtual object.

The “share flag” is a flag that can be edited by the owner of each virtual object. When the “share flag” of a certain virtual object is set to “True,” if this virtual object is positioned in the sharing area, this virtual object is made public to users other than the owner (that is, it is shared). On the other hand, when the “share flag” of a certain virtual object is set to “False,” this virtual object is not made public to users other than the owner (that is, it is not shared) even if this virtual object is positioned in the sharing area.

The “contents” indicate information that is to be expressed by each virtual object, and may include data such as the texts in a text box, the bit map of an icon, a polygon of a three-dimensional object, or the like, for example.

Additionally, permission or denial of display of each virtual object may be determined simply according to whether it is positioned in the sharing area or not. In this case, the “public flag” and the “share flag” may be omitted from the data items of the object data.

(Sharing Area Data)

FIG. 7 is an explanatory diagram for describing the sharing area data stored by the information processing apparatus 200 in the present embodiment. Referring to FIG. 7, sharing area data 214, which is an example, is shown. The sharing area data 214 includes five data items: a sharing area ID, the number of vertices, vertex coordinates, the number of users, and a registered user.

The “sharing area ID” is an identifier used for unique identification of each sharing area. The “number of vertices” and the “vertex coordinates” are data regarding the range of each sharing area in the real space. In the example of FIG. 7, a sharing area SA1 is defined as a polygon that is formed by N vertices whose positions are given by coordinates X_{A11} to X_{A1N}. A sharing area SA2 is defined by a polygon that is formed by M vertices whose positions are given by coordinates X_{A21} to X_{A2M}. The sharing area may be a three-dimensional area formed by a set of polygons, or a two-dimensional area of a polygonal or oval shape.

The “number of users” and the “registered user” are data defining a group of users (hereinafter, referred to as a user group) using each sharing area. In the example of FIG. 7, the user group for the sharing area SA1 includes N_{U1} registered users. Also, the user group for the sharing area SA2 includes N_{U2} registered users. A virtual object positioned in a certain sharing area may be made public to the users registered in the user group of this virtual object if the share flag of this virtual object is “True.” Additionally, the “number of users” and the “registered user” may be omitted from the data items of the sharing area data.

(3-3) Sharing Area Setting Unit

The sharing area setting unit 230 sets (i.e., defines) a virtual sharing area in the real space. When a sharing area is set by the sharing area setting unit 230, sharing area data as illustrated in FIG. 7 that defines this sharing area is stored in the storage unit 220.

(Example of Sharing Area)

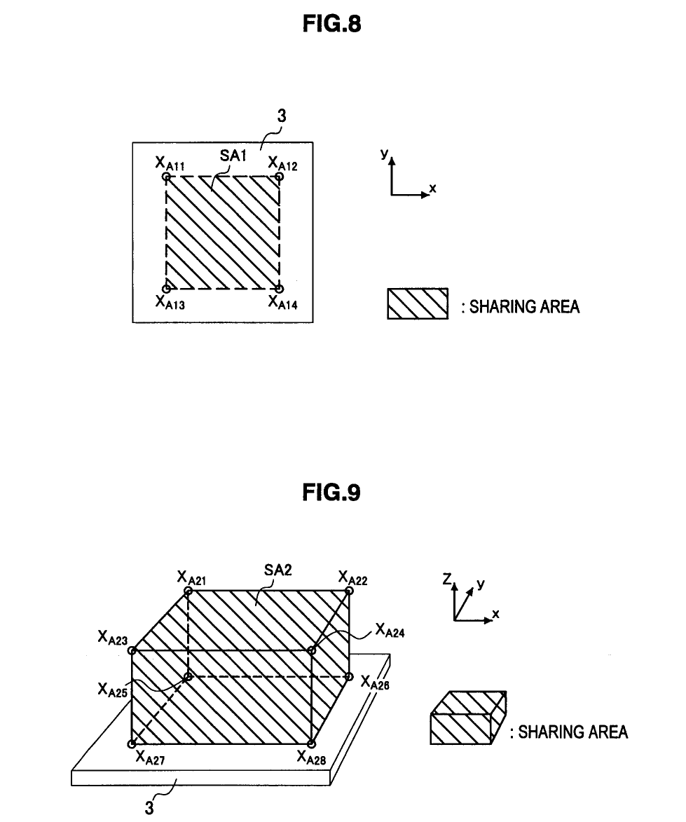

FIG. 8 is an explanatory diagram showing a first example of the sharing area that may be set by the sharing area setting unit 230. In the first example, the sharing area SA1 is a four-sided planar area having four vertices) X_{A11} to X_{A14} that is positioned on the surface of the table 3.

FIG. 9 is an explanatory diagram showing a second example of the sharing area that may be set by the sharing area setting unit 230. In the second example, the sharing area SA2 is a three-dimensional cuboid area having eight vertices X_{A21} to X_{A28} that is positioned on or above the table 3.

FIG. 10 is an explanatory diagram showing a third example of the sharing area that may be set by the sharing area setting unit 230. In the third example, a sharing area SA3 is a circular planar area with a radius R_{A3} that is centred at a point C_{A3} and that is positioned on the surface of the table 3.

As shown in FIGS. 8 to 10, the sharing area setting unit 230 may set the sharing area at a position that is associated with a predetermined real object in the real space. A predetermined real object may be a table, a whiteboard, the screen of a PC (Personal Computer), a wall, a floor, or the like, for example. Alternatively, the sharing area setting unit 230 may also set the sharing area at a specific position in the global coordinate system or the local coordinate system without associating it with a real object in the real space.

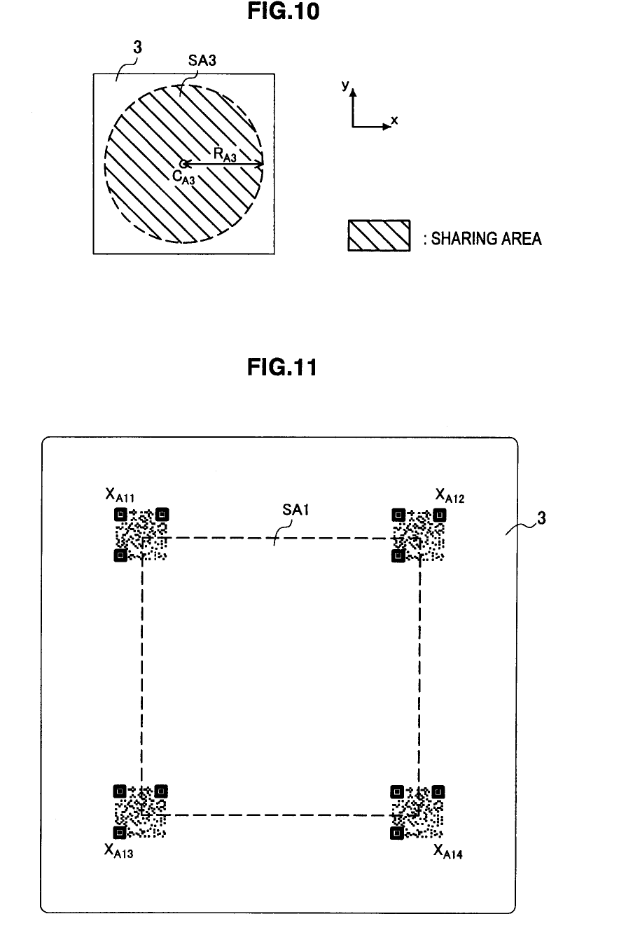

The sharing area to be set by the sharing area setting unit 230 may be fixedly defined in advance. Also, the sharing area setting unit 230 may newly set a sharing area by receiving a definition of a new sharing area from the terminal device 100. For example, referring to FIG. 11, a table 3 to which QR codes are attached at positions corresponding to the vertices of the sharing area is shown. The terminal device 100 recognises the vertices of the sharing area by capturing these QR codes, and transmits the definition of the sharing area to be formed by the vertices which have been recognized to the information processing apparatus 200. As a result, a four-sided planar sharing area as illustrated in FIG. 8 may be set by the sharing area setting unit 230. The QR code (or mark or the like) described above may also be arranged not at the vertices of the sharing area but at the centre.

(User Group)

Furthermore, in the present embodiment, the sharing area setting unit 230 sets, for each sharing area, a user group that is obtained by grouping users who uses the sharing area. After setting a certain sharing area, the sharing area setting unit 230 may broadcast a beacon to terminal devices 100 in the periphery to invite users who are to use the sharing area which has been set, for example. Then, the sharing area setting unit 230 may register the user of the terminal device 100 which has responded to the beacon as the user who will use the sharing area (the “registered user” of the sharing area data 214 in FIG. 7). Alternatively, the sharing area setting unit 230 may receive a request for registration to the sharing area from the terminal device 100, and register the user of the terminal device 100 which is the transmission source of the request for registration which has been received as the user who will use the sharing area.

(3-4) Sharing Control Unit

The sharing control unit 240 controls display of the virtual object at the terminal device 100 that presents the AR space used for information sharing between users. More particularly, the sharing control unit 240 permits or denies display of each virtual object at each terminal device 100 depending on whether each virtual object is positioned in the sharing area or not. Also, in the present embodiment, the sharing control unit 240 permits or denies display of each virtual object at each terminal device 100 depending on the attribute of each virtual object. Then, the sharing control unit 240 distributes, to each terminal device 100, object data of the virtual object whose display at the terminal device 100 is permitted. Alternatively, the sharing control unit 240 distributes, to each terminal device 100, object data of the virtual object regardless of whether its display is permitted at any particular terminal device 100. In such embodiments, the sharing control unit 240 distributes, to each terminal device, object data representing a specified orientation of the virtual object whose display at the terminal device 100 is permitted. For example, the specified orientation may be a face-up orientation. The sharing control unit 240 could also distribute, to each terminal device, object data representing multiple orientations of the virtual object, at least one of which can only be displayed at a terminal device 100 that is permitted to display the virtual object. In one exemplary embodiment, the virtual objects could be virtual playing cards, and the multiple orientations could be face-up and face-down orientations. In such an embodiment, a given terminal device 100 might be able to display certain virtual playing cards in the face-up orientation (e.g., those that are “dealt” to a user of the given terminal device 100) but only be able to display other virtual playing cards in the face-down orientation (e.g., those that are “dealt” to individuals other than the user of the given terminal device 100).

For example, the sharing control unit 240 permits display of a certain virtual object at the terminal device 100 of the owner user of the virtual object regardless of whether the virtual object is positioned in the sharing area or not. Also, in a case a certain virtual object has a public attribute, the sharing control unit 240 permits display of the virtual object at every terminal device 100 regardless of whether the virtual object is positioned in the sharing area or not. Permission or denial of display of a virtual object not having the public attribute at the terminal device 100 of a user other than the owner user of the virtual object is determined according to the value of the “share flag” and the position of the virtual object.

For example, when a certain virtual object is set to a non-shared object by the owner user, the sharing control unit 240 denies display of the virtual object at the terminal device 100 of a user other than the owner user even if the virtual object is positioned in the sharing area. On the other hand, when a certain virtual object is set to a shared object, the sharing control unit 240 permits display of the virtual object at the terminal device 100 of a user other than the owner user of the virtual object if the virtual object is positioned in the sharing area. In this case, the terminal device 100 at which display of the virtual object is permitted may be the terminal device 100 of a user belonging to the user group of the sharing area in which the virtual object is positioned. The sharing control unit 240 may determined that the virtual object is positioned in the sharing area in the case the virtual object is entirely included in the sharing area. Alternatively, the sharing control unit 240 may determine that the virtual object is positioned in the sharing area in the case the virtual object is partially overlapped with the sharing area.

Furthermore, the sharing control unit 240 updates, according to operation of the virtual object detected at each terminal device 100, the position and the attitude included in the object data of the virtual object which has been operated. Thereby, the virtual object can be easily shared between the users or the sharing can be easily ended simply by a user operating the virtual object (a shared object whose share flag is “True”) and moving the virtual object to the inside or outside of the sharing area.

### 4. Example of Flow of Process

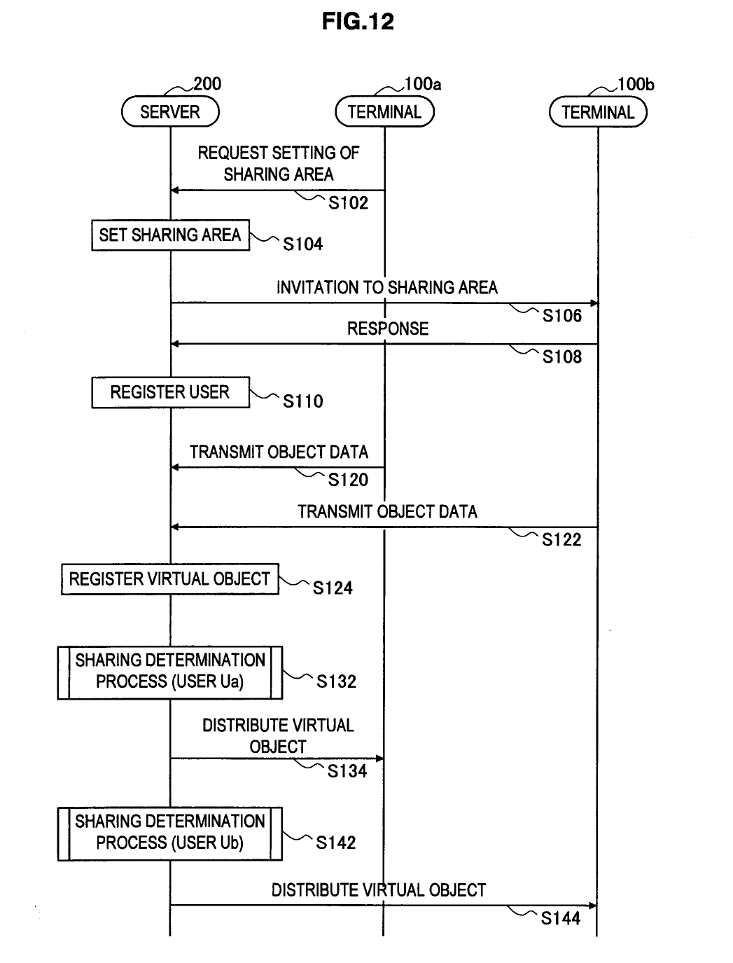

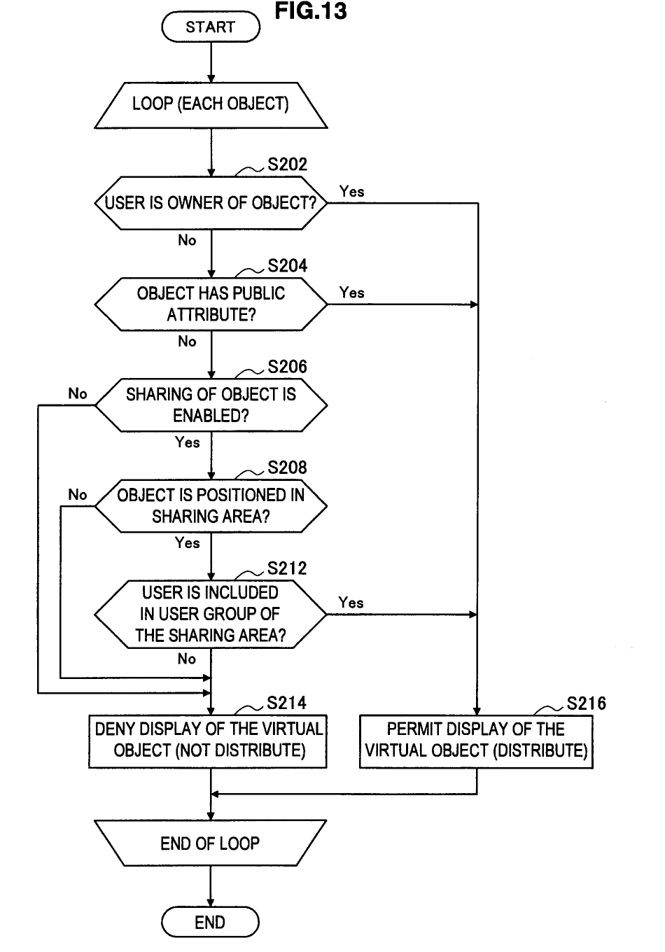

Next, the flow of processes at the information sharing system 1 according to the present embodiment will be described with reference to FIGS. 12 and 13.

(4-1) Overall Flow

FIG. 12 is a sequence chart showing an example of the flow of a process up to the start of information sharing in the information sharing system 1. Additionally, for the sake of simplicity of the explanation, it is assumed here that only the terminal devices 100a and 100b of two users Ua and Ub are participating in the information sharing system 1.

Referring to FIG. 12, first, the terminal device 100a requests setting of a sharing area to the information processing apparatus 200 (step S102). Then, the sharing area setting unit 230 of the information processing apparatus 200 sets a new sharing area (step S104). Then, the sharing area setting unit 230 transmits to the terminal device 100b a beacon for inviting a user for the newly set sharing area (step S106). The terminal device 100b which has received this beacon responds to the invitation to the sharing area (step S108). Here, it is assumed that the user Ub of the terminal device 100b has accepted the invitation. Then, the sharing area setting unit 230 of the information processing apparatus 200 registers the user Ub in the user group of the new sharing area (step S110).

Next, the terminal device 100a transmits to the information processing apparatus 200 the object data of the virtual object generated at the terminal device 100a (that is, the virtual object whose owner is the user Ua) (step S120). Likewise, the terminal device 100b transmits to the information processing apparatus 200 the object data of the virtual object generated at the terminal device 100b (step S122). The object data as illustrated in FIG. 6 is thereby registered (or updated) in the storage unit 220 of the information processing apparatus 200 (step S124). Such registration or update of the object data may be performed periodically, or may be performed aperiodically at a timing of operation of the virtual object.

Next, the sharing control unit 240 of the information processing apparatus 200 performs a sharing determination process for each user. For example, the sharing control unit 240 first performs the sharing determination process for the user Ua (step S132), and distributes to the terminal device 100a the object data of a virtual object whose display at the terminal device 100a is permitted (step S134). Next, the sharing control unit 240 performs the sharing determination process for the user Ub (step S142), and distributes to the terminal device 100b the object data of a virtual object whose display at the terminal device 100b is permitted (step S144).

(4-2) Flow of Sharing Determination Process

FIG. 13 is a flow chart showing an example of the flow of the sharing determination process for each user (hereinafter, referred to as a target user) by the sharing control unit 240 of the information processing apparatus 200. The processing of steps S202 to S216 in FIG. 13 is performed for each virtual object included in the object data 212.

First, the sharing control unit 240 determines whether the target user is the owner of a virtual object or not (step S202). Here, in the case the user is the owner of a virtual object, the sharing control unit 240 permits display of the virtual object to the target user (step S216). On the other hand, in the case the target user is not the owner of the virtual object, the process proceeds to step S204.

Next, the sharing control unit 240 determines whether the virtual object has the public attribute or not (step S204). Here, in the case the virtual object has the public attribute, the sharing control unit 240 permits display of the virtual object to the target user (step S216). On the other hand, in the case the virtual object does not have the public attribute, the process proceeds to step S206.

Next, the sharing control unit 240 determines whether sharing of the virtual object is enabled or not (step S206). Here, in the case sharing of the virtual object is not enabled (that is, the share flag is “False”), the sharing control unit 240 denies display of the virtual object to the target user (step S214). On the other hand, in the case sharing of the virtual object is enabled, the process proceeds to step S208.

Next, the sharing control unit 240 determines whether the virtual object is positioned in the sharing area or not (step S208). Here, in the case the virtual object is not positioned in the sharing area, the sharing control unit 240 denies display of the virtual object to the target user (step S214). On the other hand, in the case the virtual object is positioned in the sharing area, the process proceeds to step S212.

In step S212, the sharing control unit 240 determines whether or not the target user is included in the user group of the sharing area in which the virtual object is positioned (step S212). Here, in the case the target user is included in the user group, the sharing control unit 240 permits display of the virtual object to the target user (step S216). On the other hand, in the case the target user is not included in the user group, the sharing control unit 240 denies display of the virtual object to the target user (step S214).

(4-3) Calculation of Display Position

Additionally, transformation of the coordinates, in relation to the virtual object whose display has been permitted by the information processing apparatus 200, from a three-dimensional position indicated by the object data to a two-dimensional display position on the screen may be performed according to a pinhole model such as the following formula, for example.

λC_{obj}=AΩ(X_{obj}−X_{c}) (1)

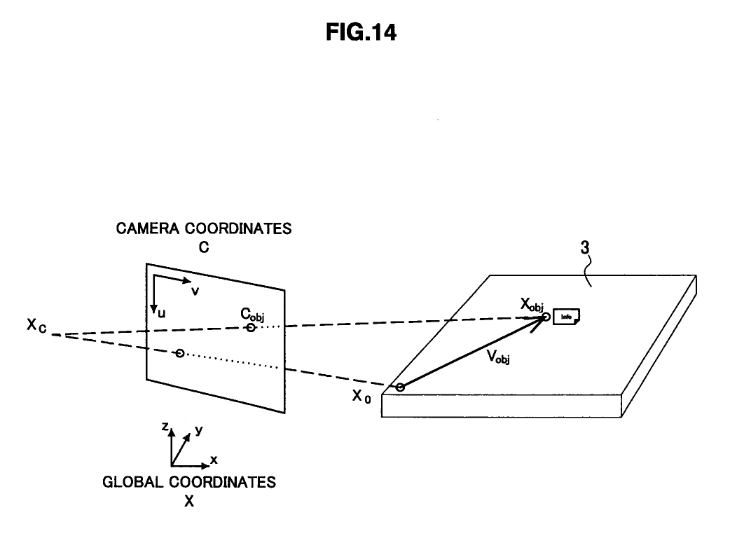

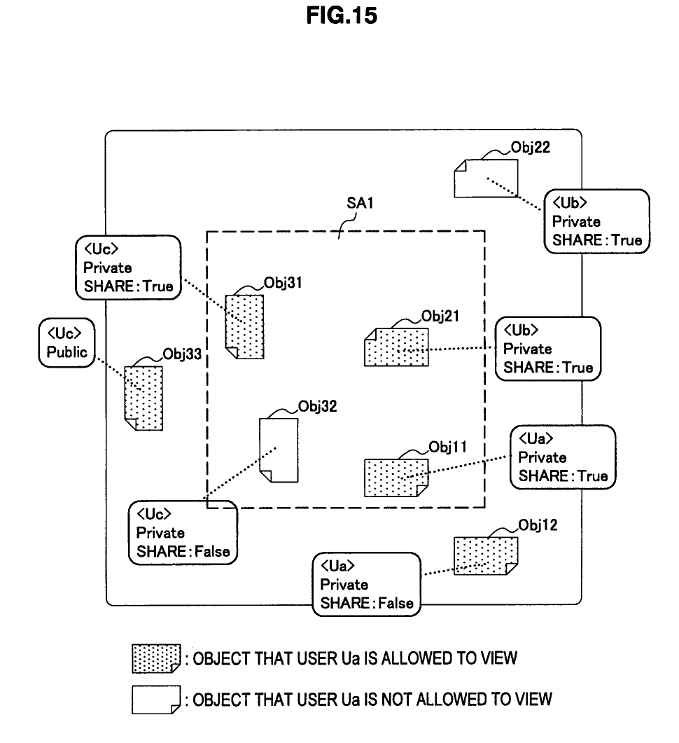

In Formula (1), X_{obj} is a vector indicating the three-dimensional position of the virtual object in the global coordinate system or the local coordinate system, X_{c} is a vector indicating the three-dimensional position of the terminal device 100, Ω is a rotation matrix corresponding to the attitude of the terminal device 100, matrix A is a camera internal parameter matrix, and X is a parameter for normalization. Also, C_{obj} indicates the display position of the virtual object in a two-dimensional camera coordinate system (u, v) on the image plane (see FIG. 14). In the case the three-dimensional position of the virtual object is given by a relative position V_{obj} from the position X₀ of the real object, X_{obj} may be calculated by the following formula.

X_{obj}=X₀+V_{obj} (2)

The camera internal parameter matrix A is given in advance as the following formula according to the property of the imaging unit 102 of the terminal device 100.

$$A = ( \begin{matrix}- f \cdot {k}_{u} & f \cdot {k}_{u} \cdot cot θ & {u}_{O} \\ 0 & - \frac{f \cdot {k}_{v}}{sin θ} & {v}_{O} \\ 0 & 0 & 1\end{matrix} ) \qquad ( 3 )$$

Here, f is the focal length, θ is the orthogonality of an image axis (ideal value is 90 degrees), kᵤ is the scale of the vertical axis of the image plane (rate of change of scale from the coordinate system of the real space to the camera coordinate system), kᵥ is the scale of the horizontal axis of the image plane, and (uₒ, vₒ) is the centre position of the image plane.

### 5. Examples of Shared Information and Non-Shared Information

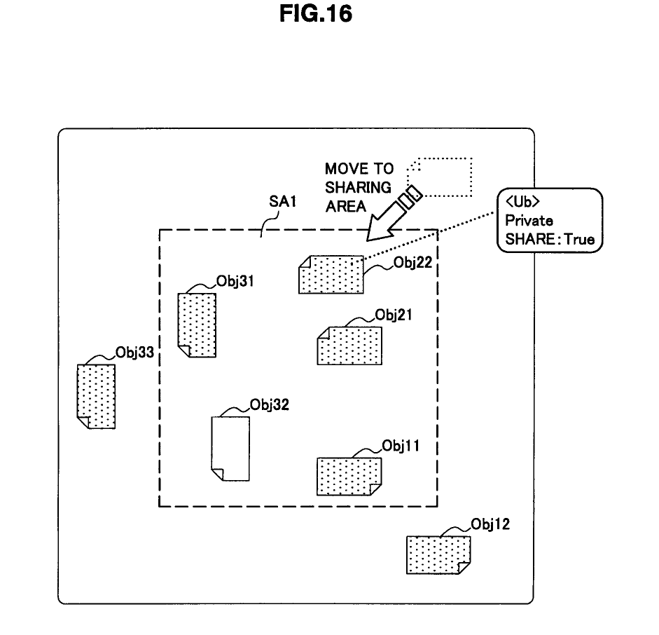

FIG. 15 is an explanatory diagram showing examples of shared information and non-shared information in the information sharing system 1. In FIG. 15, a plurality of virtual objects arranged within or outside the sharing area SA1 are shown. Additionally, it is assumed here that the users Ua, Ub, and Uc are participating in the information sharing system 1. Dotted virtual objects in the drawing are objects that the user Ua is allowed to view (that is, objects whose display at the terminal device 100a is permitted). On the other hand, virtual objects that are not dotted are objects that the user Ua is not allowed to view (that is, objects whose display at the terminal device 100a is denied).

The owner of the objects Obj11 and Obj12, among the virtual objects shown in FIG. 15, is the user Ua. Accordingly, the objects Obj11 and Obj12 can be viewed by the user Ua regardless of their attributes.

On the other hand, the owner of the objects Obj21 and Obj22 is the user Ub. The owner of the objects Obj31, Obj32, and Obj33 is the user Uc. Among these virtual objects, the object Obj33 has the public attribute, and can therefore be viewed by the user Ua. Also, since the share flags of the objects Obj21 and Obj31 are “True” and they are positioned within the sharing area, they can be viewed by the user Ua. Although the share flag of the object Obj22 is “True,” it is positioned outside the sharing area, and therefore the user Ua is not allowed to view the object Obj22. Although the object Obj32 is positioned within the sharing area, its share flag is “False,” and therefore the user Ua is not allowed to view the object Obj32.

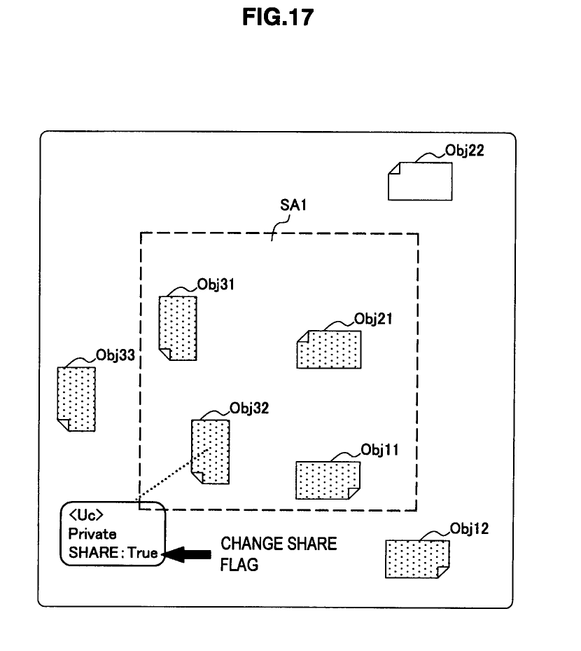

FIGS. 16 and 17 are each an explanatory diagram for describing a scenario for sharing information that was non-shared in FIG. 15. Referring to FIG. 16, the object Obj22 is moved by the user Ub from the outside of the sharing area to the inside. As a result, the user Ua is enabled to view the object Obj22. Also, referring to FIG. 17, the share flag of the object Obj32 is changed from “False” to “True” by the user Uc. As a result, the user Ua is enabled to view the object Obj32. In contrast, in the case the virtual object is moved from the inside of the sharing area to the outside, or in the case the share flag of the virtual object is changed to “False,” the virtual object which was shared will not be shared anymore.

### 6. Modified Example

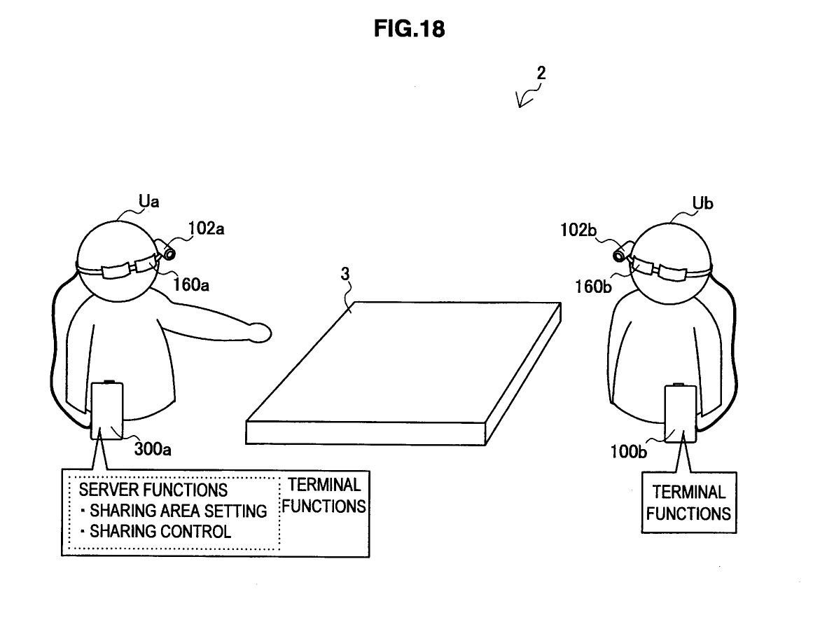

In the above-described embodiment, an example has been described where the information processing apparatus 200 is configured as a device separate from the terminal device 100 which is held or worn by a user. However, if any of the terminal devices has the server function of the information processing apparatus 200 (mainly the functions of the sharing area setting unit 230 and the sharing control unit 240), the information processing apparatus 200 may be omitted from the configuration of the information sharing system. FIG. 18 shows the overview of an information sharing system 2 according to such a modified example. Referring to FIG. 18, the information sharing system 2 includes a terminal device 300a to be worn by a user Ua and a terminal device 100b to be worn by a user Ub. The terminal device 300a includes, in addition to the function of the terminal device 100 described above, the server function described in association with the information processing apparatus 200. On the other hand, the terminal device 100b includes the function of the terminal device 100 described above. Also with such an information sharing system 2, as with the information sharing system 1, the user is enabled to easily handle information desired to be shared with other users in the AR space and information not desired to be shared.

### 7. Summary

In the foregoing, an embodiment (and its modified example) of the present disclosure has been described with reference to FIGS. 1A to 18. According to the embodiment described above, display of each virtual object for the augmented reality at a terminal device is permitted or denied depending on whether or not the virtual object is positioned in the sharing area that is virtually set in the real space. Thus, the user can share information desired to be shared with another user by performing an operation of simply moving the virtual object indicating the information to the inside of the sharing area. At that time, a complicated operation such as switching of the layer of the AR space is not necessary.

Furthermore, according to the present embodiment, display of a certain virtual object at the terminal of the owner user of the virtual object is permitted regardless of whether the virtual object is positioned in the sharing area or not. Accordingly, the user can freely arrange information he/she has generated within or outside the sharing area.

Furthermore, according to the present embodiment, in the case a certain virtual object has a public attribute, display of the virtual object at the terminal device is permitted regardless of whether the virtual object is positioned in the sharing area or not. Accordingly, with respect to certain types of information, it is possible to have it freely viewed by a plurality of users without imposing restrictions on sharing, by attaching the public attribute thereto in advance.

Furthermore, according to the present embodiment, if a certain virtual object is set to a non-shared object, display of the virtual object at the terminal device of a user other than the owner user of the virtual object will be denied even if the virtual object is positioned in the sharing area. Accordingly, the user is enabled to arrange information not desired to be shared with other users, among the information that he/she has generated, in the sharing area while not allowing other users to view the information.

Furthermore, according to the present embodiment, display of the virtual object positioned in each sharing area is permitted to the terminal device of a user belonging to the user group of the sharing area. Accordingly, information can be prevented from being unconditionally viewed by users who just happened to walk by the sharing area, for example.

Furthermore, according to the present embodiment, the sharing area can be set to a position that is associated with a specific real object in the real space. That is, a real object such as a table, a whiteboard, the screen of a PC, a wall, or a floor in the real space may be treated as the space for information sharing using the augmented reality. In this case, a user is enabled to more intuitively recognize the range of the sharing area.

Additionally, in the present specification, an embodiment of the present disclosure has been described mainly taking as an example sharing of information at a meeting attended by a plurality of users. However, the technology described in the present specification can be applied to various other uses. For example, the present technology may be applied to a physical bulletin board, and a sharing area may be set on the bulletin board instead of pinning paper to the bulletin board, and a virtual object indicating information to be shared may be arranged on the sharing area. Also, the present technology may be applied to a card game, and a virtual object indicating a card to be revealed to other users may be moved to the inside of the sharing area.

Furthermore, the series of control processes by each device described in the present specification may be realized by using any of software, hardware, and a combination of software and hardware. Programs configuring the software are stored in advance in a storage medium (i.e., a non-transitory, computer-readable storage medium) provided within or outside each device, for example. Each program is loaded into a RAM (Random Access Memory) at the time of execution, and is executed by a processor such as a CPU (Central Processing Unit), for example.

It should be understood by those skilled in the art that various modifications, combinations, sub-combinations and alterations may occur depending on design requirements and other factors insofar as they are within the scope of the appended claims or the equivalents thereof.

For example, the present technology can adopt the following configurations.

(1) An information processing apparatus comprising:

a storage unit for storing position data indicating a position of at least one virtual object superimposed onto a real space and displayed on a screen of at least one terminal device;

a sharing area setting unit for setting at least one virtual sharing area in the real space; and

a control unit for permitting or denying display of each virtual object at the at least one terminal device depending on whether each virtual object is positioned in the at least one sharing area or not.

(2) The information processing apparatus according to the (1),

wherein the control unit permits display of a certain virtual object at a terminal device of an owner user of the certain virtual object regardless of whether the certain virtual object is positioned in the at least one sharing area or not.

(3) The information processing apparatus according to the (1) or (2),

wherein, in a case a certain virtual object has a public attribute, the control unit permits display of the certain virtual object at every terminal device regardless of whether the certain virtual object is positioned in the at least one sharing area or not.

(4) The information processing apparatus according to any one of the (1) to (3),

wherein, when a certain object is set to a non-shared object by an owner user of the certain virtual object, the control unit denies display of the certain virtual object at a terminal device of a user other than the owner user of the certain virtual object even if the certain virtual object is positioned in the at least one sharing area.

(5) The information processing apparatus according to any one of the (1) to (4),

wherein the sharing area setting unit sets a user group for each of the at least one sharing area, and

wherein the control unit permits a terminal device of a user belonging to the user group of each sharing area to display a virtual object positioned in the sharing area.

(6) The information processing apparatus according to any one of the (1) to (5),

wherein the at least one sharing area is set at a position associated with a specific real object in the real space.

(7) The information processing apparatus according to any one of the (1) to (6),

wherein the control unit updates, according an operation on the virtual object detected at each terminal device, the position data of the virtual object which has been operated.

(8) the information processing apparatus according to any one of the (1) to (7),

wherein the information processing apparatus is one of a plurality of the terminal devices.

(9) An information sharing method performed by an information processing apparatus storing, in a storage medium, position data indicating a position of at least one virtual object superimposed onto a real space and displayed on a screen of a terminal device, comprising:

setting a virtual sharing area in the real space; and

permitting or denying display of each virtual object at the terminal device depending on whether each virtual object is positioned in the sharing area or not.

(10) A program for causing a computer for controlling an information processing apparatus storing, in a storage medium, position data indicating a position of at least one virtual object superimposed onto a real space and displayed on a screen of a terminal device to operate as:

a sharing area setting unit for setting a virtual sharing area in the real space; and

a control unit for permitting or denying display of each virtual object at the terminal device depending on whether each virtual object is positioned in the sharing area or not.

(11) A terminal device comprising:

an object control unit for acquiring, from an information processing apparatus storing position data indicating a position of at least one virtual object, a virtual object, the acquired virtual object being permitted to be displayed according to a positional relationship between a virtual sharing area set in a real space and the virtual object; and

a display unit for superimposing the virtual object acquired by the object control unit onto the real space and displaying the virtual object.

(12) The terminal device according to the (11),

wherein the display unit further displays an auxiliary object for allowing a user to perceive the sharing area.

(13) The terminal device according to claim the (11) or (12),

wherein the object control unit causes the virtual object displayed by the display unit to move according to a user input.

(14) The terminal device according to any one of the (11) to (13), further comprising:

a communication unit for transmitting a new position of the virtual object which has been moved according to the user input, to the information processing apparatus.

What is claimed is:

1. An apparatus for sharing virtual objects, comprising:
a communication unit configured to receive position data indicating a position of a virtual object relative to a real space; and
a sharing control unit configured to:
compare the position of the virtual object to a sharing area that is defined relative to the real space; and
selectively permit display of the virtual object by a display device, based on a result of the comparison.

2. The apparatus of claim 1, wherein the sharing control unit is configured to selectively permit display of the virtual object by selectively distributing object data representing the virtual object to a remote device.

3. The apparatus of claim 2, wherein the sharing control unit is configured to selectively permit display of the virtual object by selectively distributing object data representing a specified orientation of the virtual object.

4. The apparatus of claim 3, wherein the sharing control unit is configured to selectively permit display of the virtual object by selectively distributing object data representing a face-up orientation of the virtual object.

5. The apparatus of claim 1, wherein the sharing control unit is configured to distribute object data representing multiple orientations of the virtual object, at least one of which can only be displayed by a display device that is permitted to display the virtual object.

6. The apparatus of claim 1, comprising a sharing area defining unit configured to define a position of the sharing area relative to a real object in the real space.

7. The apparatus of claim 6, wherein the sharing area defining unit is configured to store sharing area data associated with at least one user.

8. The apparatus of claim 1, wherein the sharing control unit is configured to store object data indicating the position of the virtual object.

9. The apparatus of claim 8, wherein the sharing control unit is configured to:
store object data indicating whether the virtual object is public or private; and
when the virtual object is public, permit display of the virtual object by the display device.

10. The apparatus of claim 8, wherein the sharing control unit is configured to:
store object data indicating an owner of the virtual object; and
permit display of the virtual object by a display device used by the owner.

11. The apparatus of claim 10, wherein the sharing control unit is configured to:
store object data indicating whether the virtual object is private;
store object data indicating whether the virtual object is shareable; and
when the virtual object is private and not shareable, deny display of the virtual object by a display device other than the display device used by the owner.

12. The apparatus of claim 11, wherein the sharing control unit is configured to, when the virtual object is private, shareable, and positioned within the sharing area, permit display of the virtual object by a display device other than the display device used by the owner.

13. The apparatus of claim 11, wherein the sharing control unit is configured to, when the virtual object is private, shareable, and not positioned within the sharing area, deny display of the virtual object by a display device other than the display device used by the owner.

14. The apparatus of claim 1, wherein the sharing control unit is configured to compare the position of the virtual object to a circular sharing area that is defined relative to the real space.

15. The apparatus of claim 1, wherein the sharing control unit is configured to compare the position of the virtual object to a rectangular sharing area that is defined relative to the real space.

16. A method of sharing virtual objects, comprising:
receiving position data indicating a position of a virtual object relative to a real space;
comparing the position of the virtual object to a sharing area that is defined relative to the real space; and
selectively permitting display of the virtual object by a display device, based on a result of the comparison.

17. A non-transitory, computer-readable storage medium storing a program that, when executed by a processor, causes an apparatus to perform a method of sharing virtual objects, the method comprising:
receiving position data indicating a position of a virtual object relative to a real space;
comparing the position of the virtual object to a sharing area that is defined relative to the real space; and
selectively permitting display of the virtual object by a display device, based on a result of the comparison.

18. An apparatus for sharing virtual objects, comprising:
a storage medium storing a program; and
a processor configured to execute the program to cause the apparatus to perform a method of sharing virtual objects, the method comprising:
receiving position data indicating a position of a virtual object relative to a real space;
comparing the position of the virtual object to a sharing area that is defined relative to the real space; and
selectively permitting display of the virtual object by a display device, based on a result of the comparison.

19. An apparatus for sharing virtual objects, comprising:
communication means for receiving position data indicating a position of a virtual object relative to a real space; and
sharing means for:
comparing the position of the virtual object to a sharing area that is defined relative to the real space; and
selectively permitting display of the virtual object by a display device, based on a result of the comparison.
